(19) United States
(12) Patent Application Publication
(10) Pub. No.: US 2025/0253577 A1
(43) Pub. Date: Aug. 7, 2025

(54) Connector and Cap

(71) Applicants: Tyco Electronics (Shanghai) Co., Ltd., Shanghai (CN); Tyco Electronics UK LTD, Swindon (GB); TE Connectivity Italia Distribution S.r.l., Torino (IT)

(72) Inventors: Yongjia (Winter) Wang, Shanghai (CN); Zhiyi Li, Shanghai (CN); Federico Lupo, Torino (IT); John Marsh, Wiltshire (GB)

(73) Assignees: Tyco Electronics (Shanghai) Co., Ltd., Shanghai (CN); Tyco Electronics UK LTD, Swindon (GB); TE Connectivity Italia Distribution S.r.l., Torino (IT)

(21) Appl. No.: 19/046,644

(22) Filed: Feb. 6, 2025

(30) Foreign Application Priority Data
Feb. 6, 2024 (CN) 202410172223.X

(51) Int. Cl. H01R 13/502; H01R 4/2429

(52) U.S. Cl. CPC H01R 13/502; H01R 4/2429

(57) ABSTRACT

A connector includes a cap having a first main body that includes a first opening slot and a second opening slot staggered in a first direction. The first opening slot has a first concave portion and the second opening slot has a second concave portion. The first concave portion and the second concave portion are arranged opposite to each other in a second direction. The first opening slot and the second opening slot are used together to accommodate a cable. An extension direction of the cable within the cap is the first direction; the second direction is perpendicular to the first direction. The connector includes a terminal piercing the cable to form an electrical connection with the cable and a housing accommodating the terminal.

### CROSS-REFERENCE TO RELATED APPLICATION

This application claims the benefit of the filing date under 35 U.S.C. § 119(a)-(d) of Chinese Patent Application No. 202410172223.X, filed on Feb. 6, 2024.

### FIELD OF THE DISCLOSURE

This disclosure relates to the field of connector technology, and more particularly to a connector and a cap.

### BACKGROUND OF THE INVENTION

FIGS. 1, 2, and 3 jointly illustrate a connector in the prior art, which comprises a cap 10, a terminal 20, and a housing 30. The cap 10 is provided with a nearly circular slot 101, which is used to receive and accommodate cables. The cap 10 also includes a hooking portion 102, which is used to engage with a hooking cooperating portion 301 on the housing 30 to securely connect the cap 10 to the housing 30, as shown in FIG. 4.

In the connector shown in FIGS. 1-4, however, the slot 101 and hooking portion 102 of the connector have inwardly concave structures, which form undercuts 103 during injection molding, preventing mold release. During the injection molding process, the cap 10 of this connector often requires a slider to complete mold ejection. As the mold opening of this connector is difficult, the manufacturing process of the product becomes complex, production costs increase, and the forming quality is difficult to ensure.

### SUMMARY OF THE INVENTION

A connector includes a cap having a first main body that includes a first opening slot and a second opening slot staggered in a first direction. The first opening slot has a first concave portion and the second opening slot has a second concave portion. The first concave portion and the second concave portion are arranged opposite to each other in a second direction. The first opening slot and the second opening slot are used together to accommodate a cable. An extension direction of the cable within the cap is the first direction; the second direction is perpendicular to the first direction. The connector includes a terminal piercing the cable to form an electrical connection with the cable and a housing accommodating the terminal.

### BRIEF DESCRIPTION OF THE DRAWINGS

The invention will now be described by way of example with reference to the accompanying figures, of which:

FIG. 1 shows a three-dimensional schematic view of a cap in the prior art;

FIG. 2 shows a three-dimensional schematic view of a terminal in the prior art;

FIG. 3 shows a three-dimensional schematic view of a housing in the prior art;

FIG. 4 shows a three-dimensional schematic view of the cooperation between the cap and the housing in the prior art;

FIG. 5 shows a three-dimensional schematic view of a cap according to an embodiment of the present disclosure;

FIG. 6 shows a three-dimensional schematic view of a terminal according to an embodiment of the present disclosure;

FIG. 7 shows a three-dimensional schematic view of a housing according to an embodiment of the present disclosure;

FIG. 8 shows a side view of a cap according to an embodiment of the present disclosure;

FIG. 9 shows a three-dimensional schematic view of a cap from another perspective according to an embodiment of the present disclosure;

FIG. 10 shows a side view of a cap according to an embodiment of the present disclosure, which also illustrates a demolding surface example for the end cap;

FIG. 11 shows a schematic diagram of an assembly step for connecting a connector according to an embodiment of the present disclosure;

FIG. 12 shows a schematic diagram of another assembly step for connecting a connector according to an embodiment of the present disclosure;

FIG. 13 shows a schematic diagram of another assembly step for connecting a connector according to an embodiment of the present disclosure; and

FIG. 14 shows a side view of FIG. 11 looking along the-z direction.

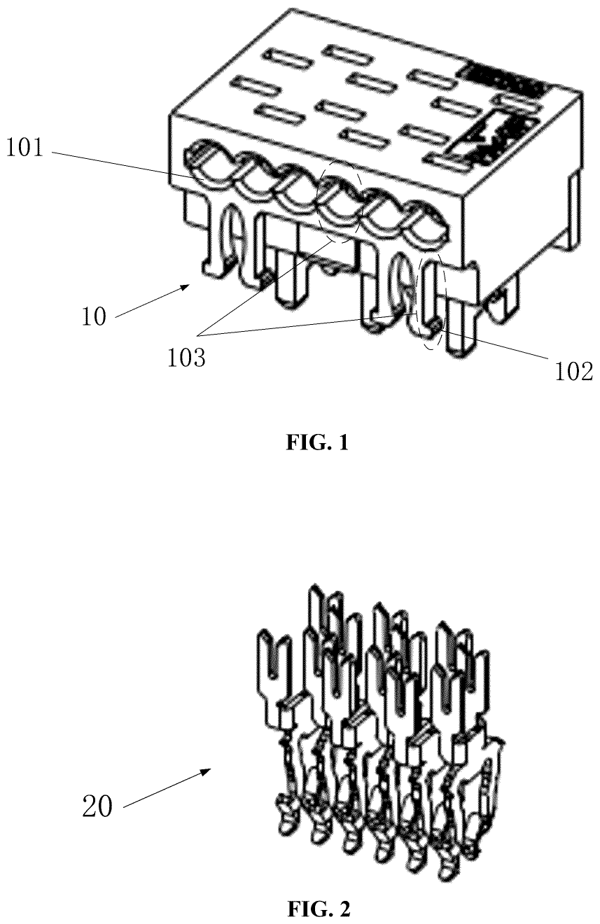

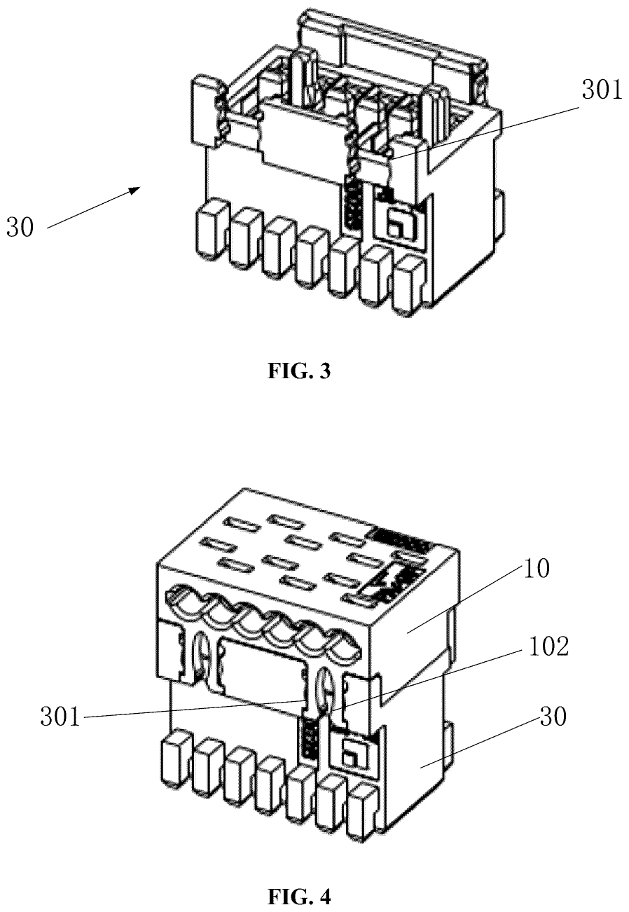

### DETAILED DESCRIPTION

The technical solution of the present disclosure is described in detail below through embodiments and in conjunction with the accompanying drawings. The same or similar reference numerals throughout the description indicate the same or similar components. The following description of the embodiments of the present disclosure with reference to the accompanying drawings is intended to explain the overall inventive concept of the present disclosure and should not be construed as a limitation to the present disclosure.

The terms “includes”, “comprises” and the like used in the present disclosure should be interpreted as open-ended terms, i.e., “includes/comprises but is not limited to”, indicating that other elements may also be included. The term “based on” indicates “at least partly based on”. The term “one embodiment” indicates “at least one embodiment”. The term “another embodiment” indicates “at least one additional embodiment”.

To solve the defects of the prior art, the present disclosure proposes a connector, in which the cap of the connector does not have undercuts during mold opening, thereby making the injection molding of the connector more convenient.

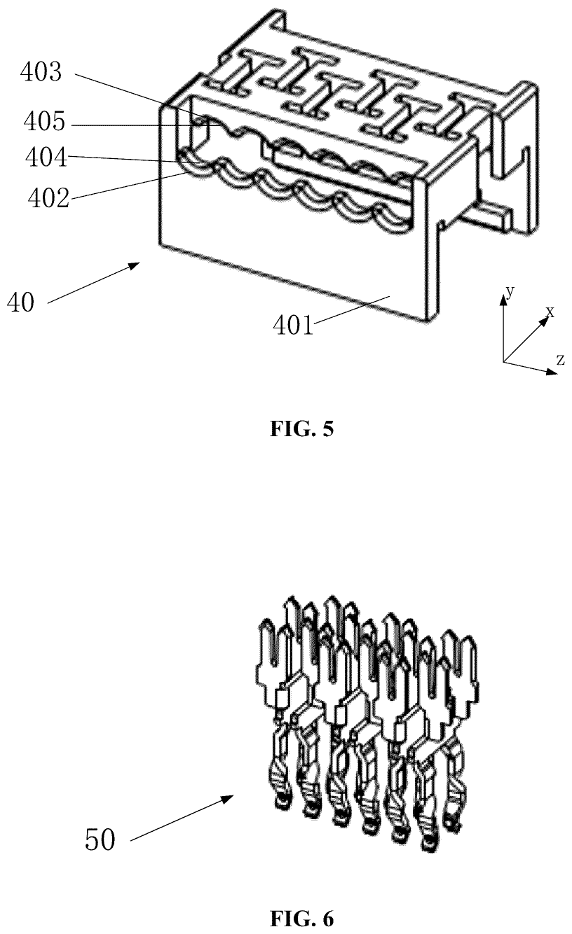

The connector proposed in this disclosure includes a cap 40, a terminal 50, and a housing 60. FIGS. 5, 6, and 7 respectively show three-dimensional schematic views of the cap 40, terminal 50, and housing 60 according to an embodiment of the present disclosure. The cap 40 is used to accommodate a cable 70, the terminal 50 is used to pierce the cable 70 to form an electrical connection with the cable 70, and the housing 60 is used to accommodate the terminal 50. The cap 40 and housing 60 can be made of plastic material through injection molding processes. The terminal 50 is made of metal.

Referring to FIG. 5, the cap 40 includes a first main body 401, which includes a first opening slot 402 and a second opening slot 403. The first opening slot 402 includes a first concave portion 404 disposed on it, and the second opening slot 403 includes a second concave portion 405 disposed on it. The first concave portion 404 and the second concave portion 405 are disposed in opposition to each other in the y direction. FIG. 8 further shows a side view of the cap 40 looking along the-z direction. It can be observed that the first opening slot 402 and the second opening slot 403 are staggered in the x direction, which avoids the formation of undercuts during the molding process of the first opening slot 402 and the second opening slot 403. The first opening slot 402 and the second opening slot 403 are used together to accommodate the cable 70, thereby fixing the cable 70 in the cap 40. Referring to FIG. 12 below, the x direction is the direction in which the cable 70 extends within the end cap 40, and the y direction is perpendicular to the x direction.

In this embodiment, the first concave portion 402 and the second concave portion 403 are both arcuate concave portions. The arcuate concave portions are more closely matched to the circular cross-section of the cable, limiting the cable in as little space as possible. In other examples, the concave portions may also be square, diamond-shaped, or any other suitable shape as long as they can accommodate the cable.

In this embodiment, the y direction is the direction of gravity. In other examples, the y direction may be inclined at a certain angle relative to the direction of gravity.

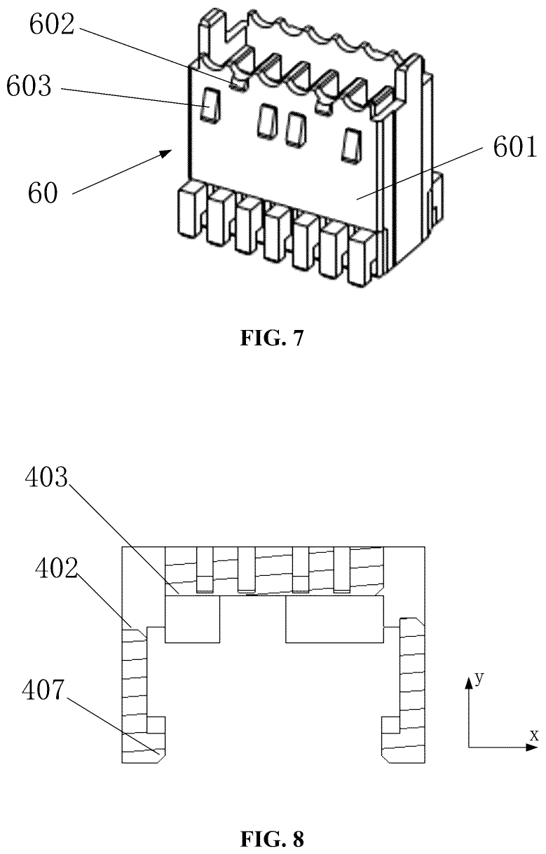

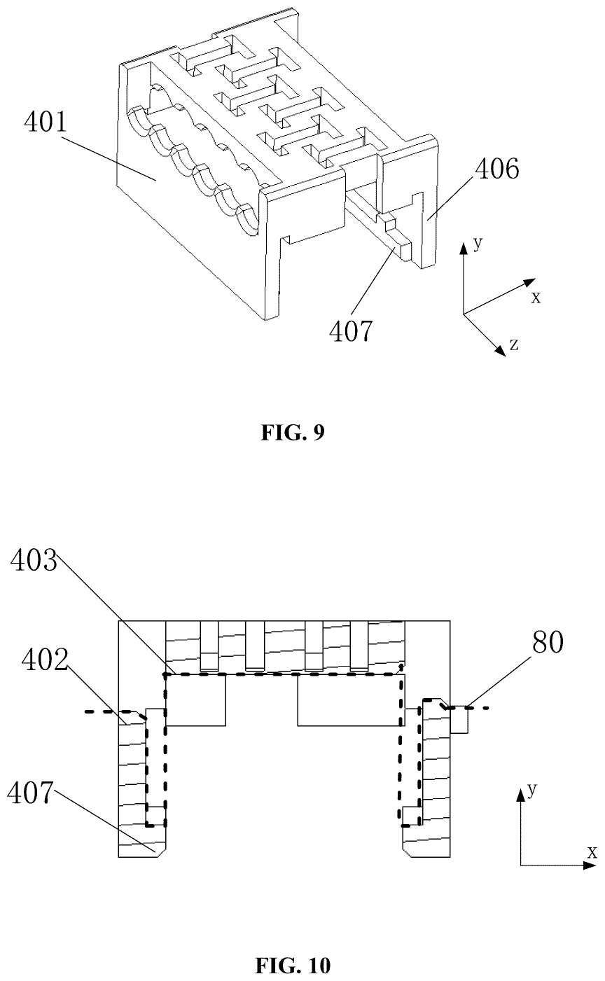

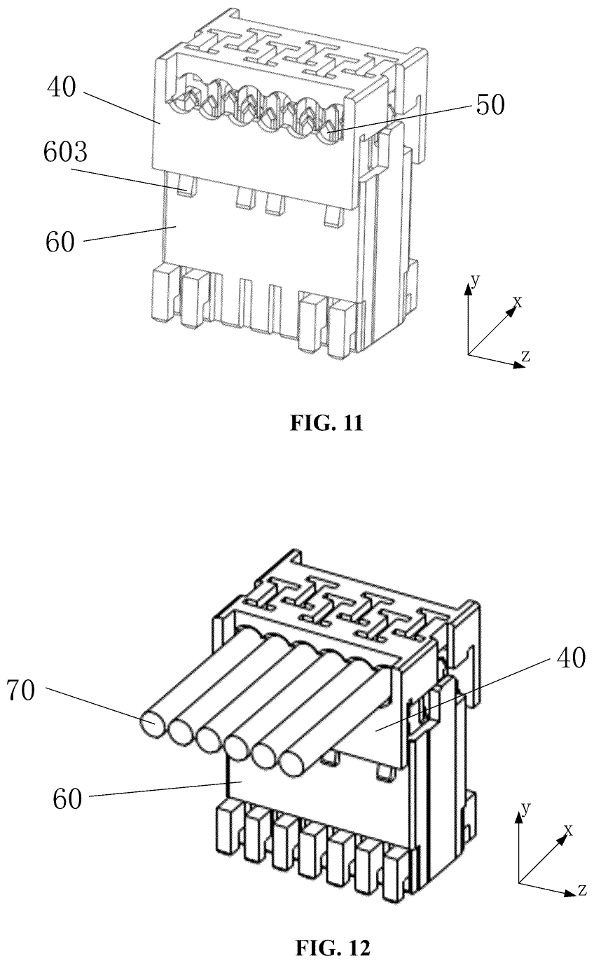

FIG. 9 shows a three-dimensional view of the cap 40 according to another perspective of the embodiment of the present disclosure. The first main body 401 of the cap 40 further includes a cantilever 406, which has a retaining hook 407 disposed at its free end. As can be observed in combination with FIG. 8, the retaining hook 407 is staggered in the x direction with respect to the first opening slot 402 and also with respect to the second opening slot 403. This arrangement avoids the formation of undercuts during the molding process of the retaining hook 407. Referring to FIG. 7, the housing 60 of the connector further includes a second main body 601, which includes a first retaining member 602 disposed on it. As shown in FIG. 11, the retaining hook 407 can be used to engage with the first retaining member 602 to fix the cap 40 at the first retaining member 602 of the housing 60.

FIG. 10 shows a mold-release surface 80 for the cap 40 in one embodiment. This mold-release surface 80 is provided as an example for releasing the cap 40 during molding. By adopting the design proposed in this disclosure, an operator can remove the cap 40 by lifting and lowering along the mold-release surface 80 shown in FIG. 10, without the need for auxiliary tools such as slides, simplifying the manufacturing process and saving costs compared to existing technologies. In this embodiment, the retaining hook 407 is arranged in the x direction between the first opening slot 402 and the second opening slot 403.

Additionally, the second main body 601 of the housing 60 may further include a second retaining member 603 disposed on it, as shown in FIG. 7. In this case, the retaining hook 407 can be detached from the first retaining member 602 and fixedly connected to the second retaining member 603, thereby fixing the cap 40 at the second retaining member 603 of the housing 60.

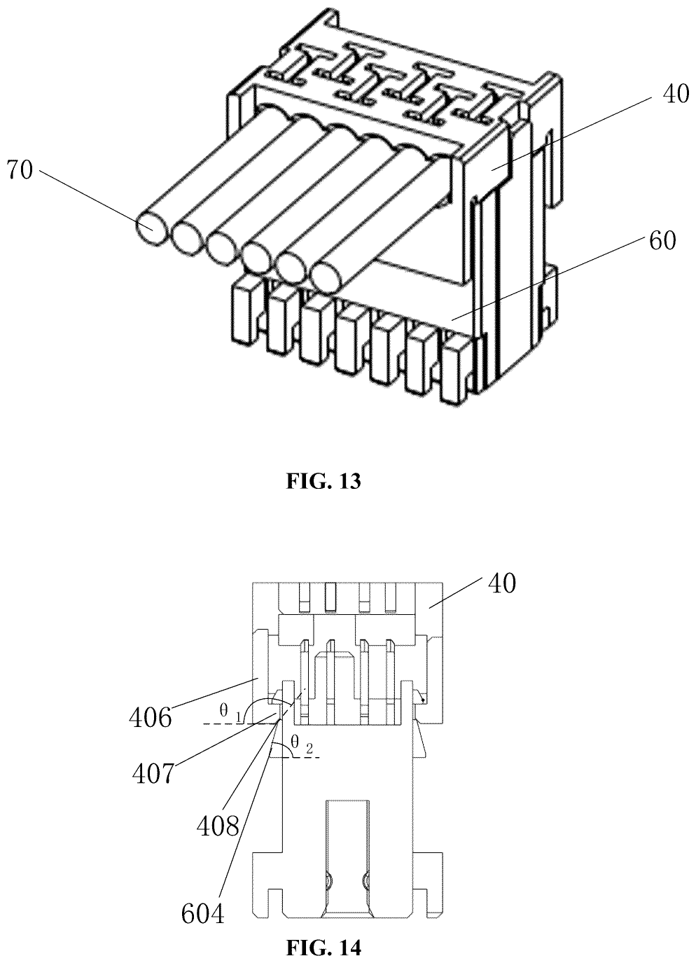

FIGS. 11 to 13 successively illustrate the assembly process of the connector. In the first step of the assembly process, as shown in FIG. 11, the terminal 50 is first inserted into the housing 60, and then the cap 40 is fixed to the housing 60, with the retaining hook 407 of the cap 40 being fixedly connected to the first retaining member 602 of the housing 60. In the second step of the assembly process, as shown in FIG. 12, the cable 70 is installed in the cap 40. In the third step of the assembly process, as shown in FIG. 13, the cap 40 is pressed down to detach the retaining hook 407 from the first retaining member 602 and then fixedly connected to the second retaining member 603. At the same time, the terminal 50 inside the housing 60 pierces through the cable 70 and forms an electrical connection with it.

FIG. 14 further shows a side view of FIG. 11 looking along the −z direction. It can be observed that the retaining hook 407 of the cap 40 is configured to extend towards the interior of the cap 40 from the cantilever 406. Since the retaining hook 407 is disposed within the end cap 40, its size can be flexibly adjusted. Referring to FIG. 9, the width of the retaining hook 407 along the z direction can be made close to the width of the cap 40 along the z direction, which provides a strong bonding force between the retaining hook 407 and the retaining member, making it difficult for the cap 40 to separate from the housing 60. Compared to FIG. 4 showing existing technology, where the hooking portion 102 is disposed on the outer periphery of the cap 10 and extends towards both sides, it is not suitable for making the structure of the hooking portion 102 too large, resulting in a weak bonding force between the cap 10 and the housing 30.

Continuing with reference to FIG. 14, the retaining hook 407 includes a first inclined surface 408, the inclined surface 408 extends in a direction that forms an angle θ1 with a horizontal direction extending from its base towards the retaining hook 407, where the angle θ1 is greater than 90 degrees and less than 180 degrees. At least one of the first retaining member 602 and the second retaining member 603 includes a second inclined surface 604, the inclined surface 604 extends in a direction that forms an angle θ2 with a horizontal direction extending from its base towards the retaining member, where the angle θ2 is greater than 0 degrees and less than 90 degrees. The first inclined surface 408 and the second inclined surface 604 are configured to facilitate engagement of the retaining hook 407 with the retaining member during downward pressure on the cap 40, and also facilitate detachment of the retaining hook 407 from the first retaining member 602 for engagement with the second retaining member 603.

Additionally, this disclosure also proposes a cap 40 for accommodating a cable 70. The cap 40 includes a first main body 401, which includes a first opening slot 402 and a second opening slot 403. The first opening slot 402 includes a first concave portion 404 disposed on it, and the second opening slot 403 includes a second concave portion 405 disposed on it. In this embodiment, the first opening slot 402 and the second opening slot 403 are staggered in the x direction, and the first concave portion 404 and the second concave portion 405 are arranged opposite to each other in the y direction. The first opening slot 402 and the second opening slot 403 are used together to accommodate the cable 70. In one embodiment, both the first concave portion 404 and the second concave portion 405 are arcuate recessed portions. In another embodiment, the y direction is the direction of gravity.

Additionally, the first main body 401 further comprises a cantilever 406, the cantilever 406 includes a retaining hook 407 disposed at its free end. The retaining hook 407 is configured to engage with a retaining member of the housing 60 of the connector housing (e.g., the first retaining member 602 or the second retaining member 603) to achieve a fixed connection. In this embodiment, the retaining hook 407 is staggered with respect to the first opening slot 402 and the second opening slot 403 in the x direction. In one embodiment, the retaining hook 407 is disposed between the first opening slot 402 and the second opening slot 403 in the x direction. In another embodiment, the retaining hook 407 is configured to extend towards the interior of the cap 40 from the cantilever 406.

Although the embodiments of the present disclosure have been described with reference to several specific embodiments, it should be understood that embodiments of the present disclosure are not limited to the specific embodiments disclosed herein. Embodiments of the present disclosure are intended to cover all possible modifications and equivalent arrangements that are included within the spirit and scope of the appended claims. The scope of the claims conforms to the broadest interpretation and thus encompasses all such modifications and equivalent structures and functions.

1. A connector, comprising:
a cap having a first main body that includes a first opening slot and a second opening slot staggered in a first direction, the first opening slot has a first concave portion and the second opening slot has a second concave portion, the first concave portion and the second concave portion are arranged opposite to each other in a second direction, the first opening slot and the second opening slot are used together to accommodate a cable, an extension direction of the cable within the cap is the first direction, the second direction is perpendicular to the first direction;
a terminal piercing the cable to form an electrical connection with the cable; and
a housing accommodating the terminal.

2. The connector according to claim 1, wherein the first concave portion and the second concave portion are both arcuate concave portions.

3. The connector according to claim 1, wherein the second direction is a direction of gravity.

4. The connector according to claim 1, wherein the first main body has a cantilever, the cantilever includes a retaining hook disposed at a free end, the retaining hook is staggered with respect to the first opening slot and the second opening slot in the first direction.

5. The connector according to claim 4, wherein the housing has a second main body including a first retaining member disposed on the second main body.

6. The connector according to claim 5, wherein the retaining hook engages the first retaining member to fix the cap at a position of the first retaining member of the housing.

7. The connector according to claim 6, wherein the retaining hook is disposed between the first opening slot and the second opening slot in the first direction.

8. The connector according to claim 6, wherein the retaining hook extends towards an interior of the cap from the cantilever.

9. The connector according to claim 8, wherein the second main body of the housing has a second retaining member.

10. The connector according to claim 9, wherein the retaining hook is detachable from the first retaining member and fixedly connectable to the second retaining member, fixing the cap at the second retaining member of the housing.

11. The connector according to claim 10, wherein the retaining hook includes a first inclined surface, the first inclined surface extending in a direction that forms a first angle with a horizontal direction extending from a base of the first inclined surface towards the retaining hook, the first angle is greater than 90 degrees and less than 180 degrees.

12. The connector according to claim 11, wherein at least one of the first retaining member and the second retaining member includes a second inclined surface, the second inclined surface extending in a direction that forms a second angle with a horizontal direction extending from a base of the second inclined surface towards the retaining member, the second angle is greater than 0 degrees and less than 90 degrees.

13. A cap, comprising:
a main body including a first opening slot and a second opening slot staggered in a first direction, the first opening slot has a first concave portion and the second opening slot has a second concave portion, the first concave portion and the second concave portion are arranged opposite to each other in a second direction, the first opening slot and the second opening slot are used together to accommodate a cable, an extension direction of the cable within the cap is the first direction, the second direction is perpendicular to the first direction.

14. The cap of claim 13, wherein the first concave portion and the second concave portion are both arcuate concave portions.

15. The cap of claim 13, wherein the second direction is the direction of gravity.

16. The cap of claim 13, wherein the main body has a cantilever, the cantilever includes a retaining hook disposed at a free end, the retaining hook engages a retaining member of a housing to form a fixed connection.

17. The cap of claim 16, wherein the retaining hook is staggered with respect to the first opening slot and the second opening slot in the first direction.

18. The cap of claim 16, wherein the retaining hook is disposed between the first opening slot and the second opening slot in the first direction.

19. The cap of claim 18, wherein the retaining hook extends toward an interior of the cap from the cantilever.
